(19) United States
(12) Patent Application Publication
(10) Pub. No.: US 2026/0002500 A1
(43) Pub. Date: Jan. 1, 2026

(54) COVER STRUCTURE

(71) Applicant: SUZUKI MOTOR CORPORATION, Hamamatsu-shi (JP)

(72) Inventors: Kyoma SUZUKI, Hamamatsu-shi (JP); Shogo KOUSAKA, Hamamatsu-shi (JP); Shota SAITO, Hamamatsu-shi (JP)

(73) Assignee: SUZUKI MOTOR CORPORATION, Hamamatsu-shi (JP)

(21) Appl. No.: 19/198,493

(22) Filed: May 5, 2025

(30) Foreign Application Priority Data
Jun. 28, 2024 (JP) 2024-105077

(51) Int. Cl. F02M 35/02; F02M 35/04

(52) U.S. Cl. CPC F02M 35/0205; F02M 35/048

(57) ABSTRACT

A cover structure for a straddle-type vehicle in which an air cleaner is installed inside a seat frame and a muffler is installed behind the air cleaner. The cover structure includes a frame cover covering the seat frame from an outer side in a vehicle width direction, and a muffler cover covering the muffler, below the frame cover, wherein the muffler cover includes a cover main body covering the muffler from the outer side in the vehicle width direction, and an extension portion extending between the seat frame and the muffler from the cover main body.

### CROSS-REFERENCE TO RELATED APPLICATIONS

This application is based on and claims priority under 35 USC 119 from Japanese Patent Application No. 2024-105077 filed on Jun. 28, 2024, the entire content of which is incorporated herein by reference.

### TECHNICAL FIELD

The present disclosure relates to a cover structure.

### BACKGROUND ART

In general, in an off-road type straddle-type vehicle, an air cleaner is installed behind an engine (see, for example, JP5906663B). The air cleaner is installed inside a seat frame, and fitting components such as a frame cover and rear fender are attached near the seat frame. The air cleaner is covered from the side by the frame cover, and the air cleaner is covered from the rear by the rear fender. A muffler is positioned to the side of the rear fender, and the muffler is covered from the outside by a muffler cover so that a rider does not touch a surface of the high-temperature muffler.

The air cleaner having such a layout has a problem that sand and dust kicked up by a rear wheel is easily sucked into the air cleaner. In order to prevent sand and dust from being sucked into the air cleaner, it is desirable to reduce a gap between the seat frame and fitting components such as the frame cover or rear fender. However, since the temperature near a fixing portion of the muffler becomes high, it is necessary to secure a sufficient gap between the seat frame and the fitting component. In addition, if the gap between the fitting component and the seat frame is too large, the intake air is warmed by the heat of the muffler, which deteriorates the engine performance. In addition, there is a risk of heat damage to peripheral components of the muffler.

### SUMMARY OF INVENTION

Aspect of non-limiting embodiments of the present disclosure relates to provide a cover structure capable of reducing heat damage to peripheral components of a muffler while reducing intrusion of foreign matter into an air cleaner. Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a cover structure for a straddle-type vehicle in which an air cleaner is installed inside a seat frame and a muffler is installed behind the air cleaner, the cover structure including:
a frame cover covering the seat frame from an outer side in a vehicle width direction; and
a muffler cover covering the muffler, below the frame cover,
in which the muffler cover includes:
   a cover main body covering the muffler from the outer side in the vehicle width direction; and
   an extension portion extending between the seat frame and the muffler from the cover main body.

### BRIEF DESCRIPTION OF DRAWINGS

Exemplary embodiment(s) of the present invention will be described in detail based on the following figures, wherein:

FIG. 1 is a right side view of a straddle-type vehicle according to the present embodiment;

FIG. 2 is a right side view of a periphery of a muffler according to the present embodiment;

FIG. 3 is a cross-sectional view of the periphery of the muffler in FIG. 2 taken along a line III-III; and

FIG. 4 is a bottom view of the periphery of the muffler according to the present embodiment.

### DESCRIPTION OF EMBODIMENTS

In a straddle-type vehicle according to one aspect of the present disclosure, an air cleaner is installed inside a seat frame and a muffler is installed behind the air cleaner. In a cover structure for the straddle-type vehicle, the seat frame is covered with a frame cover from an outer side in a vehicle width direction, and the muffler is covered with a muffler cover below the frame cover. The muffler is covered from the outer side in the vehicle width direction by a cover main body of the muffler cover, and the seat frame and the muffler are separated by an extension portion that extends from the cover main body. The extension portion of the muffler cover makes it difficult for hot air from the muffler and sand and dust kicked up by a rear wheel to reach the air cleaner. Hot air and sand and dust are prevented from being sucked into the air cleaner, thereby preventing a decrease in engine output. A cover range for the muffler is increased by the extension portion, and heat damage to peripheral components such as the air cleaner is prevented. Since the muffler cover is only partially extended, an appropriate range of the muffler can be covered without impairing a degree of freedom in the shape of the muffler cover.

### EMBODIMENT

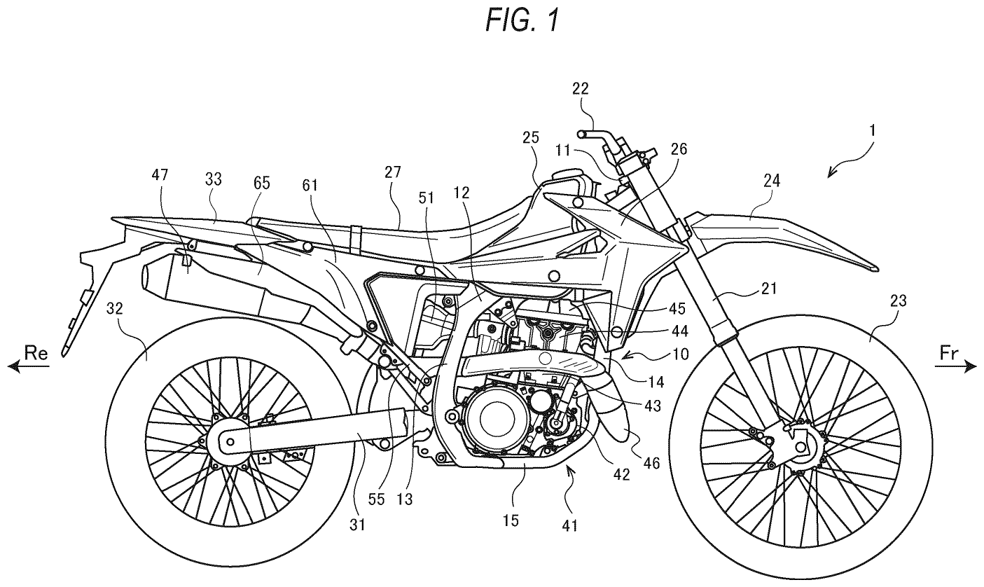

A straddle-type vehicle provided with an air cleaner according to the present embodiment will be described below with reference to the accompanying drawings. FIG. 1 is a right side view of the straddle-type vehicle according to the present embodiment. In the following drawings, an arrow Fr indicates a vehicle front side, an arrow Re indicates a vehicle rear side, an arrow L indicates a vehicle left side, and an arrow R indicates a vehicle right side.

As shown in FIG. 1, a straddle-type vehicle 1 is implemented by mounting various components such as an engine 41 and an electrical system on a vehicle body frame 10. A pair of main frames 12 extend obliquely rearward and downward from a head pipe 11 of the vehicle body frame 10, and rear portions of the pair of main frames 12 form a pair of body frames 13 bent downward. A down frame 14 extends downward from the head pipe 11. A pair of under loops 15 bent rearward are connected to a lower portion of the down frame 14. Rear end portions of the pair of under loops 15 are connected to lower portions of the pair of body frames 13, so that the vehicle body frame 10 is formed into a cradle shape.

A front fork 21 is steerably supported on the head pipe 11 via a steering shaft (not shown). A handle 22 is provided at an upper portion of the front fork 21. A front wheel 23 is rotatably supported by a lower portion of the front fork 21. A front fender 24 is provided on the front fork 21, and the front wheel 23 is covered from above by the front fender 24. A fuel tank 25 is placed over upper portions of the pair of main frames 12, and the main frames 12 and the fuel tank 25 are covered with a front side cover 26 from a lateral side. A seat 27 is installed behind the fuel tank 25.

A swing arm 31 is swingably supported on the body frame 13. The swing arm 31 extends rearward from the body frame 13, and a rear wheel 32 is rotatably supported at a rear end of the swing arm 31. A rear fender 33 is installed behind the seat 27, and the rear wheel 32 is covered from above by the rear fender 33. The engine 41 is a four-stroke single-cylinder engine. The engine 41 is suspended inside the vehicle body frame 10 via a plurality of suspension brackets. A cylinder assembly, in which a cylinder 43, a cylinder head 44, and a cylinder head cover 45 are stacked, is attached to an upper portion of a crank case 42 of the engine 41.

An exhaust pipe 46 is connected to a front surface of the cylinder head 44. The exhaust pipe 46 extends rearward passing through the right side of the cylinder 43, and an up-type muffler 47 that is tilted obliquely upward and rearward is connected to a downstream end of the exhaust pipe 46. An air cleaner 51 is located below the seat 27, and the muffler 47 is located behind the air cleaner 51. The air cleaner 51 is installed inside a pair of seat frames 55, and the pair of seat frames 55 are covered by the pair of frame covers 61 from an outer side in a vehicle width direction. The muffler 47 is covered by a muffler cover 65 below the right frame cover 61.

In a general off-road type straddle-type vehicle, a gap between a seat frame and a fitting component such as a frame cover is reduced, so that sand and dust kicked up by the rear wheel is less likely to reach an air cleaner. However, since the temperature of the seat frame and the fitting component becomes high due to the hot air from the muffler, the gap between the seat frame and the fitting component cannot be sufficiently reduced. It is conceivable to prepare a heat-resistant component to fill the gap between the seat frame and the fitting component, but there is a problem that the number of components increases. Therefore, in the present embodiment, a part of the muffler cover 65 is expanded to ensure dust resistance and to provide measures against heat damage to the peripheral components.

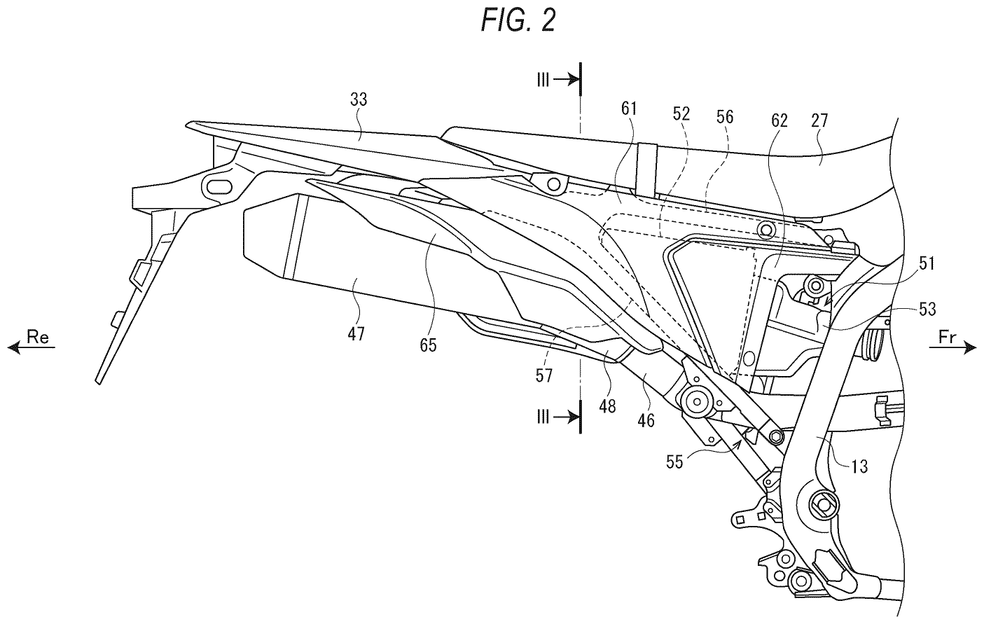

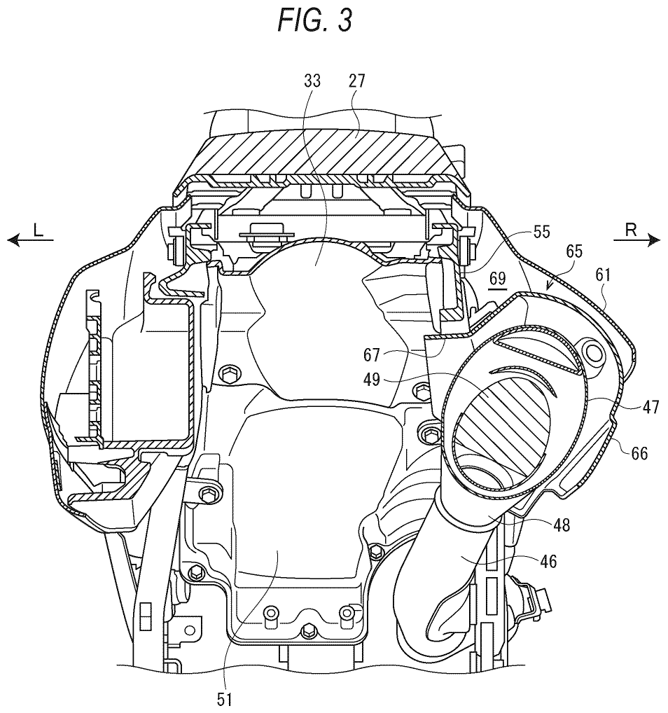

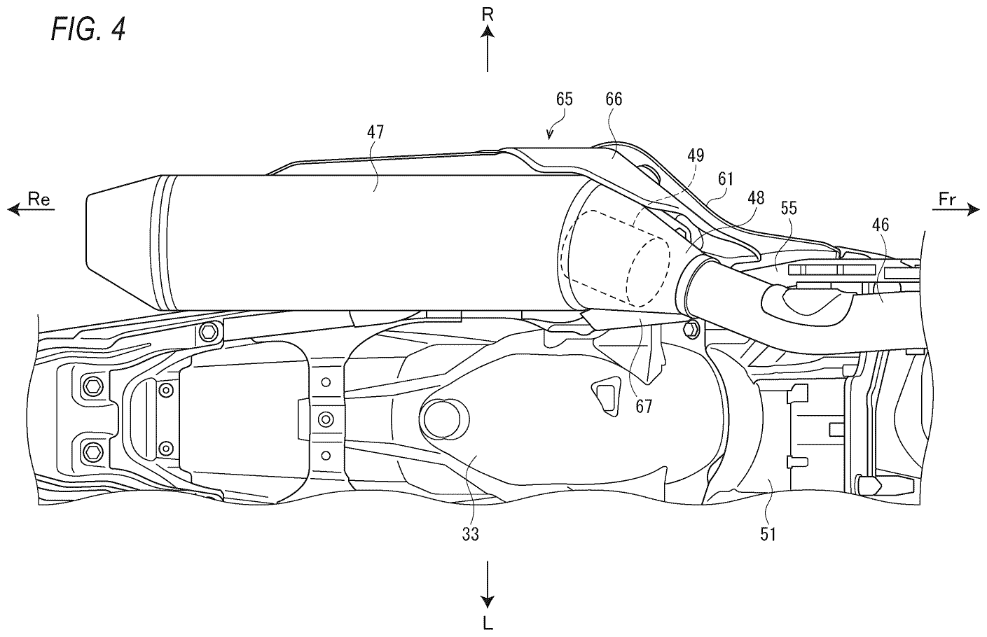

The cover structure for a straddle-type vehicle according to the present embodiment will be described with reference to FIGS. 2 to 4. FIG. 2 is a right side view of a periphery of the muffler according to the present embodiment. FIG. 3 is a cross-sectional view of the periphery of the muffler in FIG. 2 taken along a line III-III. FIG. 4 is a bottom view of the periphery of the muffler according to the present embodiment.

As shown in FIG. 2, the pair of seat frames 55 are attached to rear portions of the body frames 13, and the seat 27 is supported from below by the pair of seat frames 55. The pair of frame covers 61 having a substantially triangular shape in a side view are attached to the pair of seat frames 55. An upper edge of the frame cover 61 extends along an upper seat rail 56 of the seat frame 55, and a lower edge of the frame cover 61 extends along a lower seat rail 57 of the seat frame 55, so that the frame cover 61 entirely covers the seat frame 55. A rear side cover 62 is attached to the front side of an outer surface of the pair of frame covers 61.

The air cleaner 51 is installed in a space inside the pair of upper seat rails 56 and the pair of lower seat rails 57. The rear side of the air cleaner 51 is formed by a cleaner case 52, and the front side of the air cleaner 51 is formed by an outlet tube 53. An inlet tube (not shown) is inserted into an upper portion of the cleaner case 52, and air is taken into the air cleaner 51 from an intake port of the inlet tube. An upper side of the air cleaner 51 is covered with the seat 27, both sides of the air cleaner 51 are covered with the pair of frame covers 61, and a rear side of the air cleaner 51 is covered with the rear fender 33.

The exhaust pipe 46 passes below the air cleaner 51 and extends toward the vehicle rear side, and the muffler 47 at the rear end of the exhaust pipe 46 is positioned behind the air cleaner 51. In a side view, the muffler 47 and the air cleaner 51 are arranged in a front-rear direction with the lower seat rail 57 (seat frame 55) interposed therebetween. In this case, a rear surface of the cleaner case 52 is inclined along the lower seat rail 57, and a truncated cone portion 48 which is a front portion of the muffler 47 is positioned so as not to interfere with the lower seat rail 57. The upper and sides of the muffler 47 are covered with the heat-insulating muffler cover 65, and an upper portion of the muffler cover 65 is covered with the right frame cover 61.

As shown in FIG. 3, a space surrounded by the seat frame 55, the frame cover 61, and the muffler cover 65 is formed above the muffler 47, and air is taken in through this upper space 69 of the muffler 47 into an intake port of the air cleaner 51. The muffler 47 is covered from the outer side in the vehicle width direction and the upper side by a cover main body 66 of the muffler cover 65, and a gap between the muffler 47 and the seat frame 55 is partitioned by an extension portion 67 extending from the cover main body 66. Since the extension portion 67 fits into the gap between the muffler 47 and the seat frame 55, hot air from the muffler 47 and sand and dust kicked up by the rear wheel 32 (see FIG. 1) are less likely to flow through the upper space 69 toward the air cleaner 51.

As shown in FIGS. 3 and 4, the extension portion 67 of the muffler cover 65 is formed in an eave shape in a rear view, and an inner side of the muffler 47 in the vehicle width direction is covered from above by the extension portion 67. The extension portion 67 fits under the seat frame 55, and the extension portion 67 extends further inward in the vehicle width direction than the seat frame 55. Since the extension portion 67 is positioned further inward in the vehicle width direction than the seat frame 55, a route along which the hot air or sand and dust moves toward the upper space 69 becomes complicated. In addition, the extension portion 67 overlaps the rear fender 33 in a bottom view, so that hot air from the muffler 47 toward the rear fender 33 is blocked by the extension portion 67, thereby reducing heat damage to the rear fender 33.

The extension portion 67 of the muffler cover 65 overlaps a rear surface of the air cleaner 51 in a rear view, and the extension portion 67 of the muffler cover 65 overlaps a lower surface of the air cleaner 51 in a bottom view. Hot air from the muffler 47 toward the air cleaner 51 is blocked by the extension portion 67, thereby reducing heat damage to the air cleaner 51. Further, since the air cleaner 51 is partially covered by the extension portion 67 from the rear side and the lower side, hot air and sand and dust are less likely to reach the air cleaner 51. Thus, the extension portion 67 formed by extending a portion of the muffler cover 65 prevents hot air and sand and dust from being sucked into the air cleaner 51, thereby preventing a decrease in the engine output.

As shown in FIG. 4, the front portion of the muffler 47 is formed of the cone portion 48 having a truncated cone shape, and a catalyst 49 is installed inside the cone portion 48. The catalyst 49 is located behind the air cleaner 51. The catalyst 49 is inclined such that a front portion of the catalyst 49 is located inward of a rear portion of the catalyst 49 in the vehicle width direction in a bottom view, and the front portion of the catalyst 49 is positioned below the seat frame 55. The front portion of the cover main body 66 covers the cone portion 48 (catalyst 49), and the extension portion 67 separates the seat frame 55 and the catalyst 49 and enters inward than the catalyst 49 in the vehicle width direction. By covering the catalyst 49 with the extension portion 67, heat damage to peripheral components is effectively reduced.

A front end of the extension portion 67 is located forward of the front end of the catalyst 49, and a rear end of the extension portion 67 is located at the same position as the rear end of the catalyst 49 in the front-rear direction. As described above, since the air cleaner 51 is located in front of the catalyst 49, the extension portion 67 extends further forward than the catalyst 49, so that the hot air from the catalyst 49 toward the air cleaner 51 is effectively blocked by the extension portion 67. Further, since the rear end of the extension portion 67 is aligned with the rear end of the catalyst 49, the cover range of the extension portion 67 is minimized. With such a shape, an increase in weight is reduced without impairing the degree of freedom in the shape of the muffler cover 65.

Next, a structure for preventing entry of hot air and sand and dust will be briefly described. As shown in FIG. 3, the upper space 69 of the muffler 47 is connected to the intake port of the air cleaner 51, and the muffler 47 is covered with the muffler cover 65 from above. Even if the hot air rises from the muffler 47, the heat insulating muffler cover 65 blocks the hot air from moving toward the upper space 69. Although there is a gap between the muffler 47 and the seat frame 55, the extension portion 67 of the muffler cover 65 fits into the gap, so that hot air is less likely to flow through the upper space 69 toward the intake port. Since the gap between the extension portion 67 and the seat frame 55 is narrowed, sand and dust is less likely to flow from the rear wheel 32 through the upper space 69 to the intake port.

As described above, according to the cover structure of the straddle-type vehicle 1 of the present embodiment, the muffler cover 65 is located below the frame cover 61, and the seat frame 55 and the muffler 47 are separated by the extension portion 67 of the muffler cover 65, so that hot air from the muffler 47 and sand and dust kicked up by the rear wheel 32 are less likely to reach the air cleaner 51. Hot air and sand and dust are prevented from being sucked into the air cleaner 51, thereby preventing a decrease in engine output. The cover range for the muffler 47 is increased by the extension portion 67, and heat damage to peripheral components such as the air cleaner 51 is prevented. Since the muffler cover 65 is only partially extended, an appropriate range of the muffler 47 can be covered without impairing a degree of freedom in the shape of the muffler cover 65.

In the present embodiment, the muffler cover covers the muffler from above and from the side, but it is sufficient that the muffler cover covers at least a part of the muffler.

Further, in the present embodiment, the extension portion of the muffler cover extends further inward in the vehicle width direction than the seat frame, but the extension portion may not extend further inward in the vehicle width direction than the seat frame as long as the extension portion extends to separate the seat frame and the muffler.

In the present embodiment, the inlet tube is inserted into the upper portion of the air cleaner, and air is taken into the upper portion of the air cleaner, but the position of the inlet tube is not particularly limited. For example, an inlet tube may be inserted into a side portion of the air cleaner, and air may be taken into the side portion of the air cleaner.

The catalyst is accommodated in the front portion of the muffler in the present embodiment. Alternatively, the catalyst may not be accommodated in the muffler.

The cover structure according to the present embodiment is not limited to the above-described straddle-type vehicle, and may be used in other types of straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, a first aspect provides a cover structure for a straddle-type vehicle (1) in which an air cleaner (51) is installed inside a seat frame (55) and a muffler (47) is installed behind the air cleaner, the cover structure including: a frame cover (61) that covers the seat frame from an outer side in a vehicle width direction; and a muffler cover (65) that covers the muffler below the frame cover. The muffler cover includes: a cover main body (66) covering the muffler from the outer side in the vehicle width direction; and an extension portion (67) extending between the seat frame and the muffler from the cover main body. According to this configuration, the muffler cover is located below the frame cover, and the seat frame and the muffler are separated by the extension portion of the muffler cover, so that hot air from the muffler and sand and dust kicked up by a rear wheel are less likely to reach the air cleaner. Hot air and sand and dust are prevented from being sucked into the air cleaner, thereby preventing a decrease in engine output. A cover range for the muffler is increased by the extension portion, and heat damage to peripheral components such as the air cleaner is prevented. Since the muffler cover is only partially extended, an appropriate range of the muffler can be covered without impairing a degree of freedom in the shape of the muffler cover.

A second aspect according to the first aspect further includes a rear fender (33) that covers a rear wheel from above behind the air cleaner, in which the extension portion extends to an inner side of the seat frame in the vehicle width direction, and the extension portion overlaps the rear fender in a bottom view. According to this configuration, since the extension portion is positioned further inward in the vehicle width direction than the seat frame, a route along which the hot air or sand and dust moves toward the air cleaner becomes complicated. In addition, hot air flowing from the muffler toward the rear fender is blocked by the extension portion, and heat damage to the rear fender is reduced.

A third aspect is directed to the first or second aspect, in which the extension portion overlaps the air cleaner, in a rear view. According to this configuration, hot air from the muffler toward the air cleaner is blocked by the extension portion, thereby reducing heat damage to the air cleaner. Since the air cleaner is covered by the extension portion from behind, hot air and sand and dust are less likely to reach the air cleaner.

A fourth aspect is directed to any one of the first to third aspects, in which the extension portion overlaps the air cleaner, in a bottom view. According to this configuration, hot air from the muffler toward the air cleaner is blocked by the extension portion, thereby reducing heat damage to the air cleaner. Since the air cleaner is covered by the extension portion from below, hot air and sand and dust are less likely to reach the air cleaner.

A fifth aspect is directed to any one of the first to fourth aspects, in which a catalyst (49) is accommodated in a front portion of the muffler, the extension portion separates the seat frame and the catalyst, and the extension portion enters to an inner side of the catalyst in the vehicle width direction. According to this configuration, since the catalyst serving as a heat source is covered with the extension portion of the muffler cover, heat damage to peripheral components can be effectively reduced.

A sixth aspect is directed to the fifth aspect, in which the air cleaner is located in front of the catalyst, and a front end of the extension portion is located forward of a front end of the catalyst, and a rear end of the extension portion is located at the same position as a rear end of the catalyst, in a front-rear direction. According to this configuration, since the extension portion extends forward than the catalyst, the extension portion effectively blocks the hot air flowing from the catalyst toward the air cleaner. Further, since the rear end of the extension portion is aligned with the rear end of the catalyst, the cover range of the extension portion is minimized, and an increase in weight is reduced without impairing the degree of freedom in the shape of the muffler cover.

Although the present embodiment has been described, a part or all of the embodiment and modifications described above may be combined as another embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cover structure for a straddle-type vehicle in which an air cleaner is installed inside a seat frame and a muffler is installed behind the air cleaner, the cover structure comprising:
a frame cover covering the seat frame from an outer side in a vehicle width direction; and
a muffler cover covering the muffler, below the frame cover,
wherein the muffler cover includes:
a cover main body covering the muffler from the outer side in the vehicle width direction; and
an extension portion extending between the seat frame and the muffler from the cover main body.

2. The cover structure according to claim 1, further comprising:
a rear fender covering a rear wheel from above, behind the air cleaner,
wherein the extension portion extends to an inner side of the seat frame in the vehicle width direction, and
the extension portion overlaps the rear fender, in a bottom view.

3. The cover structure according to claim 1,
wherein the extension portion overlaps the air cleaner, in a rear view.

4. The cover structure according to claim 1,
wherein the extension portion overlaps the air cleaner, in a bottom view.

5. The cover structure according to claim 1,
wherein a catalyst is accommodated in a front portion of the muffler,
the extension portion separates the seat frame and the catalyst, and
the extension portion enters to an inner side of the catalyst in the vehicle width direction.

6. The cover structure according to claim 5,
wherein the air cleaner is located in front of the catalyst, and
a front end of the extension portion is located forward of a front end of the catalyst, and
a rear end of the extension portion is located at the same position as a rear end of the catalyst, in a front-rear direction.
